(19) United States
(12) Patent Application Publication
(10) Pub. No.: US 2026/0205389 A1
(43) Pub. Date: Jul. 16, 2026

(54) QOE REPORT CONTINUITY WITH SLICE REMAPPING

(71) Applicant: Nokia Technologies Oy, Espoo (FI)

(72) Inventors: Arled PAPA, Munich (DE); Muhammad NASEER-UL-ISLAM, Munich (DE); Halit Murat GÜRSU, Munich (DE); Ugur Baran ELMALI, Munich (DE); Ömer BULAKCI, Munich (DE); Ahmad AWADA, Munich (DE); Jing HE, Beijing (CN); Hakon HELMERS, Sceaux (FR)

(21) Appl. No.: 19/132,601

(22) PCT Filed: Dec. 8, 2022
(86) PCT No.: PCT/CN2022/137595

§ 371 Date: May 23, 2025

(51) Int. Cl. H04L 43/065; H04W 36/00

(52) U.S. Cl. CPC H04L 43/065; H04W 36/0085

(57) ABSTRACT

Embodiments of the present disclosure relate to QoE report continuity with slice remapping. A terminal device obtains a QoE measurement configuration for continuity of QoE measurement reporting. The QoE measurement configuration is indicative of a first network slice scope and a second network slice scope. The first and second network slice scopes are indicative of one or more first network slices and one or more second network slices associated with the QoE measurement reporting, respectively. At least one of the one or more first network slices is to be remapped to at least one of the one or more second network slices in an event of slice remapping. Responsive to an occurrence of the event of slice remapping, the terminal device performs the QoE measurement reporting based on the QoE measurement configuration. In this way, preservation of normal QoE measurement reporting with the introduction of slice remapping may be enabled.

### FIELD

Example embodiments of the present disclosure generally relate to the field of telecommunication, and in particular, to terminal devices, network devices, core network devices, methods, apparatuses and computer readable storage medium for Quality of Experience (QoE) report continuity in the event of slice remapping.

### BACKGROUND

Network slicing is a key 5G feature to support different services using the same underlying mobile network infrastructure. Network slices can differ either in their service requirements like Ultra-Reliable Low Latency Communication (URLLC) and enhanced Mobile Broadband (eMBB) or the tenant that provides those services.

According to current specifications, when a service is provided within a configured slice, the QoE measurement could also be configured with a certain network slice scope such that the user experience can be evaluated on a per-slice basis. In some scenarios, e.g., when the former slice is congested, or when the UE is handed over to a cell where an ongoing slice is not supported, the UE's ongoing slice may need to be remapped to another slice so as to ensure the service continuity. Enhancements on QoE measurement reporting procedures are still needed in such scenarios.

### SUMMARY

In general, example embodiments of the present disclosure provide a solution for QoE report continuity in the event of slice remapping.

In a first aspect, there is provided a terminal device for a radio access network. The terminal device comprises at least one processor and at least one memory storing instructions. The instructions, when executed by the at least one processor, cause the terminal device at least to: obtain a quality of experience, QoE, measurement configuration for continuity of QoE measurement reporting, the QoE measurement configuration being indicative of a first network slice scope and a second network slice scope, wherein the first network slice scope is indicative of one or more first network slices associated with the QoE measurement reporting and the second network slice scope is indicative of one or more second network slices associated with the QoE measurement reporting, and at least one of the one or more first network slices is to be remapped to at least one of the one or more second network slices in an event of slice remapping; and in response to an occurrence of the event of slice remapping, perform the QoE measurement reporting based on the QoE measurement configuration.

In a second aspect, there is provided a network device for a radio access network. The network device comprises at least one processor; and at least one memory storing instructions. The instructions, when executed by the at least one processor, cause the network device at least to obtain a quality of experience, QoE, measurement configuration for a terminal device for the radio access network for continuity of QoE measurement reporting, the QoE measurement configuration being indicative of a first network slice scope and a second network slice scope, wherein the first network slice scope is indicative of one or more first network slices associated with the QoE measurement reporting and the second network slice scope is indicative of one or more second network slices associated with the QoE measurement reporting, and at least one of the one or more first network slices is to be remapped to at least one of the one or more second network slices in an event of slice remapping.

In a third aspect, there is provided a core network device. The core network device comprises at least one processor; and at least one memory storing instructions. The instructions, when executed by the at least one processor, cause the core network device at least to: transmit, to a network device for a radio access network, a quality of experience, QoE, measurement configuration for a terminal device for the radio access network for continuity of QoE measurement reporting, the QoE measurement configuration being indicative of a first network slice scope and a second network slice scope, wherein the first network slice scope is indicative of one or more first network slices associated with the QoE measurement reporting and the second network slice scope is indicative of one or more second network slices associated with the QoE measurement reporting, and at least one of the one or more first network slices is to be remapped to at least one of the one or more second network slices in an event of slice remapping.

In a fourth aspect, there is provided a method. The method comprises: obtaining, by a terminal device for a radio access network, a quality of experience, QoE, measurement configuration for continuity of QoE measurement reporting, the QoE measurement configuration being indicative of a first network slice scope and a second network slice scope, wherein the first network slice scope is indicative of one or more first network slices associated with the QoE measurement reporting and the second network slice scope is indicative of one or more second network slices associated with the QoE measurement reporting, and at least one of the one or more first network slices is to be remapped to at least one of the one or more second network slices in an event of slice remapping; and in response to an occurrence of the event of slice remapping, performing the QoE measurement reporting based on the QoE measurement configuration.

In a fifth aspect, there is provided a method. The method comprises obtaining, by a network device for a radio access network, a quality of experience, QoE, measurement configuration for a terminal device for the radio access network for continuity of QoE measurement reporting, the QoE measurement configuration being indicative of a first network slice scope and a second network slice scope, wherein the first network slice scope is indicative of one or more first network slices associated with the QoE measurement reporting and the second network slice scope is indicative of one or more second network slices associated with the QoE measurement reporting, and at least one of the one or more first network slices is to be remapped to at least one of the one or more second network slices in an event of slice remapping.

In a sixth aspect, there is provided a method. The method comprises transmitting, at a core network device and to a network device for a radio access network, a quality of experience, QoE, measurement configuration for a terminal device for the radio access network for continuity of QoE measurement reporting, the QoE measurement configuration being indicative of a first network slice scope and a second network slice scope, wherein the first network slice scope is indicative of one or more first network slices associated with the QoE measurement reporting and the second network slice scope is indicative of one or more second network slices associated with the QoE measurement reporting, and at least one of the one or more first network slices is to be remapped to at least one of the one or more second network slices in an event of slice remapping.

In a seventh aspect, there is provided an apparatus. The apparatus comprises means for obtaining, at a terminal device for a radio access network, a quality of experience, QoE, measurement configuration for continuity of QoE measurement reporting, the QoE measurement configuration being indicative of a first network slice scope and a second network slice scope, wherein the first network slice scope is indicative of one or more first network slices associated with the QoE measurement reporting and the second network slice scope is indicative of one or more second network slices associated with the QoE measurement reporting, and at least one of the one or more first network slices is to be remapped to at least one of the one or more second network slices in an event of slice remapping; and means for performing the QoE measurement reporting based on the QoE measurement configuration in response to an occurrence of the event of slice remapping.

In an eighth aspect, there is provided an apparatus. The apparatus comprises means for obtaining, at a network device for a radio access network, a quality of experience, QoE, measurement configuration for a terminal device for the radio access network for continuity of QoE measurement reporting, the QoE measurement configuration being indicative of a first network slice scope and a second network slice scope, wherein the first network slice scope is indicative of one or more first network slices associated with the QoE measurement reporting and the second network slice scope is indicative of one or more second network slices associated with the QoE measurement reporting, and at least one of the one or more first network slices is to be remapped to at least one of the one or more second network slices in an event of slice remapping.

In a ninth aspect, there is provided an apparatus. The apparatus comprises means for transmitting, at a core network device and to a network device for a radio access network, a quality of experience, QoE, measurement configuration for a terminal device for the radio access network for continuity of QoE measurement reporting, the QoE measurement configuration being indicative of a first network slice scope and a second network slice scope, wherein the first network slice scope is indicative of one or more first network slices associated with the QoE measurement reporting and the second network slice scope is indicative of one or more second network slices associated with the QoE measurement reporting, and at least one of the one or more first network slices is to be remapped to at least one of the one or more second network slices in an event of slice remapping.

In a tenth aspect, there is provided an apparatus. The apparatus comprises obtaining circuitry configured to obtain a quality of experience, QoE, measurement configuration for continuity of QoE measurement reporting, the QoE measurement configuration being indicative of a first network slice scope and a second network slice scope, wherein the first network slice scope is indicative of one or more first network slices associated with the QoE measurement reporting and the second network slice scope is indicative of one or more second network slices associated with the QoE measurement reporting, and at least one of the one or more first network slices is to be remapped to at least one of the one or more second network slices in an event of slice remapping; and performing circuitry configured to perform the QoE measurement reporting based on the QoE measurement configuration in response to an occurrence of the event of slice remapping.

In an eleventh aspect, there is provided an apparatus. The apparatus comprises obtaining circuitry configured to obtain a quality of experience, QoE, measurement configuration for a terminal device for a radio access network for continuity of QoE measurement reporting, the QoE measurement configuration being indicative of a first network slice scope and a second network slice scope, wherein the first network slice scope is indicative of one or more first network slices associated with the QoE measurement reporting and the second network slice scope is indicative of one or more second network slices associated with the QoE measurement reporting, and at least one of the one or more first network slices is to be remapped to at least one of the one or more second network slices in an event of slice remapping.

In a twelfth aspect, there is provided an apparatus. The apparatus comprises transmitting circuitry configured to transmit, to a network device for a radio access network, a quality of experience, QoE, measurement configuration for a terminal device for the radio access network for continuity of QoE measurement reporting, the QoE measurement configuration being indicative of a first network slice scope and a second network slice scope, wherein the first network slice scope is indicative of one or more first network slices associated with the QoE measurement reporting and the second network slice scope is indicative of one or more second network slices associated with the QoE measurement reporting, and at least one of the one or more first network slices is to be remapped to at least one of the one or more second network slices in an event of slice remapping.

In a thirteenth aspect, there is provided a non-transitory computer readable medium comprising program instructions for causing an apparatus to perform at least the method according to any one of the above fourth to sixth aspect.

In a fourteenth aspect, there is provided a computer program comprising instructions, which, when executed by an apparatus, cause the apparatus at least to perform at least the method according to any one of the above fourth to sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example communication network in which embodiments of the present disclosure may be implemented;

FIG. 1B illustrates a schematic diagram of QoE measurement reporting procedures in the event of slice remapping in a related solution;

FIG. 1C illustrates a schematic diagram of a format of network slice identification;

FIG. 2 illustrates a flowchart illustrating a process for QoE reporting in the event of slice remapping according to some embodiments of the present disclosure;

FIGS. 3A and 3B illustrate an example of a process for QoE reporting in the event of slice remapping in accordance with some example embodiments of the present disclosure;

FIG. 4 illustrates another example of a process for QoE reporting in the event of slice remapping in accordance with some example embodiments of the present disclosure;

FIG. 5 illustrates a further example of a process for QoE reporting in the event of slice remapping in accordance with some example embodiments of the present disclosure;

FIG. 6 illustrates a flowchart of a method implemented at a terminal device according to some embodiments of the present disclosure;

FIG. 7 illustrates a flowchart of a method implemented at a network device according to some embodiments of the present disclosure;

FIG. 8 illustrates a flowchart of a method implemented at a core network device according to some other embodiments of the present disclosure;

FIG. 9 illustrates a simplified block diagram of an apparatus that is suitable for implementing embodiments of the present disclosure; and

FIG. 10 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/of” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As discussed above, network slicing is a key 5G feature to support different services using the same underlying mobile network infrastructure. Network slices can differ either in their service requirements like URLLC and eMBB or the tenant that provides those services. A network slice is uniquely identified via the Single-Network Slice Selection Assistance Information (S-NSSAI). Current 3GPP specifications allow a UE to be simultaneously connected and served by at most eight slices corresponding to eight network slices meaning eight S-NSSAIs. On other hand, each cell may support tens or even hundreds of slices. For example, in current specifications, a Tracking Area (TA) can support up to 1024 network slices.

RAN3 Rel-17 SI via TR 38.832 identified several scenarios for network slice support continuity, where remapping the slice ID of several packet data unit (PDU) sessions to another slice were proposed, e.g., when the former slice is congested. Proposals span from next generation radio access network (NG-RAN) node-based slice remapping, where the remapping policy is either generated at management/orchestration entity (OAM) or core network (CN) during NG setup/PDU session setup. For each S-NSSAI, a list of possible other S-NSSAIs were proposed to NG-RAN node from OAM/CN for the remapping. Once the RAN node decides, it informs the network to continue with the remapping process and PDU session modification procedures towards the UE. However, due to potential UE and core impact, none of the solutions was chosen for normative phase and further SA2 study was needed. In turn, SA2 Rel-18 phase 3 via TR 23.700-41 aims at providing solutions for support of network slice service continuity for no-mobility as well as inter registration area mobility scenarios, where slice remapping solutions have been proposed.

RAN #91e has agreed Rel-17 QoE WI via RP-210913 on “NR QoE management and optimizations for diverse services” with objectives such as specification of QoE measurements, definition of procedures to support QoE data collection in intra-system intra-RAT mobility scenarios, RAN visible QoE as well as QoE measurement collection per S-NSSAI. In SI phase, TP for TR 38.890 was endorsed in RAN2 #113-e (January 2021) by R2-2102483, NR QoE solutions and procedures include Signaling-based procedure and Management-based procedure as LTE, where in signaling-based procedure, the CN network initiates the activation of QoE measurements as configured by OAM, whereas in management-based procedure, the OAM sends the QoE measurement configuration directly to RAN node. For both approaches, once RAN node identifies the UE or UEs that match a certain criterion, for instance area scope, service type, network slice scope, then the RAN node forwards the QoE measurement configuration to UE Access Stratum (AS) layer, which in turn sends it to the UE Application (APP) layer. The RAN node encapsulates the configuration in a transparent container, which is then sent to the UE as Application layer configuration in the RRCReconfiguration message. On the other hand, all measurement reports generated from UE APP layer are encapsulated in a transparent container and sent to the network in the MeasurementReportAppLayer messages as per [3GPP TS 38.331].

As an outcome of the above study, as per [3GPP TS 38.300] when a service is provided within a configured slice, the QoE measurement could also be configured with a certain network slice scope such that the user experience can be evaluated on a per-slice basis. The UE APP layer includes the slice ID inside the QoE report container when reporting the QoE measurement. For QoE in Rel-17, UE APP layer is not aware of the network slice scope, however for QoE in Rel-18, it has been agreed that the UE APP will have network slice scope knowledge.

For RRC_CONNECTED state mobility, the source RAN node may transmit the QoE measurement configuration of a specific UE to the target RAN node via XnAP or NGAP, where for signaling-based QoE, information such as area scope, network slice scope and measurement status are transferred to the target RAN node. For signaling-based QoE, at handover to a target RAN node that support QoE, it is the target RAN node that decides which of the application layer measurement configurations are kept based on configuration information received in Xn/NG signaling.

From the network slicing perspective, Rel-18 SA2 TR 23.700-41 is considering slice remapping as a potential solution to overcome slice PDU session discontinuity when the UE moves to a RAN node where the slice where the UE operates is not supported at all or when the slice is currently not available. In that regard, the potential of mapping the PDU sessions of that slice for a UE towards another slice that is available on that RAN node is suggested such that PDU session continuity is preserved. However, while such a solution provides PDU session continuity for the UE, current framework of QoE network slice scope is not applicable to the concept of slice-remapping that is to be specified in Rel-18 and brings inconsistencies between APP layer and the AS layer, which may break the principles of QoE reporting of Rel-17.

According to embodiments of the present disclosure, there is providing a solution for QoE report continuity in the event of slice remapping. In particular, the present disclosure proposes a new solution to overcome those inconsistencies between APP layer and the AS layer and enable the preservation of normal QoE measurement reporting with the introduction of the slice remapping feature.

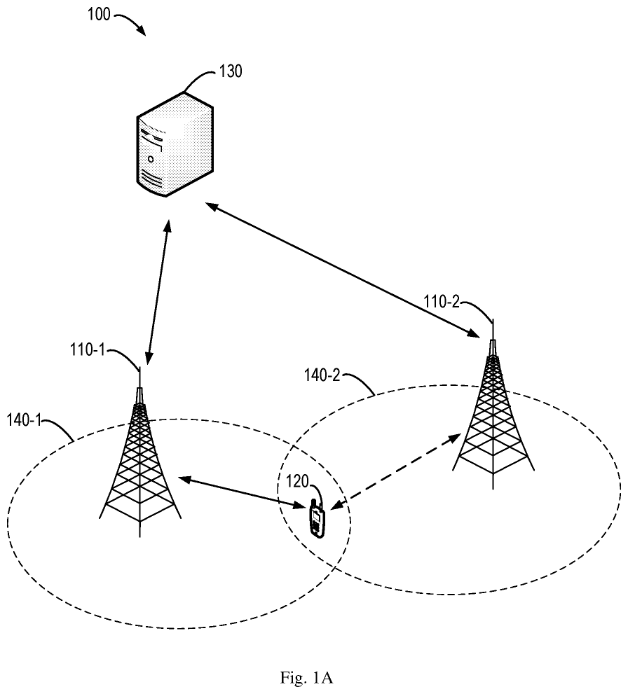

Principle and embodiments of the present disclosure will be described in detail below with reference to the accompanying drawings. Reference is first made to FIG. 1A, which illustrates an example communication system 100 in which embodiments of the present disclosure may be implemented. The communication system 100 includes a terminal device 120, a first access network device 110-1 and a second access network device 110-2 (collectively referred to as access network devices 110 or network devices 110) and a core network device 130. The access network devices 110-1, 110-2 serve respective areas 140-1 and 140-2 (also called as cells 140-1 and 140-2). In some embodiments, the cells 140-1 and 140-2 may be overlapped and use different frequency bands in both DL and UL to avoid interference.

As shown in FIG. 1A, the terminal device 120 is capable of connecting and communicating in an UL and DL with either or both of the network devices 110-1, 110-2 as long as the terminal device is located within the corresponding cells. The terminal device 120 may access one cell 140-1 provided by the first access network device 110-1. For example, the terminal device 120 may be initially connected to the cell 140-1 provided by the first access network device 110-1. Based on measurements or due to the mobility of the terminal device 120, one or more handover (HO) procedures may be performed, e.g., from the cell 140-1 provided by the first access network device 110-1 to another cell 140-2 provided by the second access network device 110-2.

In addition to communicating with the terminal device 120, the access network devices 110-1, 110-2 may also communicate with each other, for example, via a backhaul link. The communications between the terminal device 120 and the core network device 130 may be performed via one or more of the access network devices 110. The access network devices 110 may communicate with the core network device 130 and the core network device 130 may provide various services to the terminal devices 120 via the access network devices 110.

It is to be understood that the number of access network devices, core network devices and terminal devices is only for the purpose of illustration without suggesting any limitations. The system 100 may include any suitable number of access network devices, core network devices and terminal devices adapted for implementing embodiments of the present disclosure.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

The source cell 140-1 may support a network slice X for providing a service requested by the terminal device 120. Network slice remapping may occur along with HO procedure from the source cell 140-1 to the target cell 140-2, e.g., if the current ongoing slice X is overloaded in the target cell 140-2 or if the target cell 140-2 does not support the current ongoing slice X. In addition, network slice remapping may also occur when the terminal device 120 communicates with the first access network device 110-1 without HO procedure, e.g., if the ongoing slice X is overloaded in the cell 140-1.

As discussed above, the slice remapping might create a set of inconsistencies with respect to QoE reporting. FIG. 1B illustrates a schematic diagram of a QoE measurement reporting procedure 150 in the event of slice remapping in a related solution. FIG. 1B is depicted and will be described from perspectives of measurement collection entity/trace collection entity (MCE/TCE) 131, OAM/CN 133, source RAN node 110-1, target RAN node 110-2, UE AS 121 and UE APP layer 123. For the purpose of discussion, the process 150 will be described with reference to FIG. 1A. The process 150 may involve the terminal device 120, the access network devices 110-1, 110-2 and the core network device 130 as illustrated in FIG. 1A. In particular, the MCE/TCE 131 and OAM/CN 133 may correspond to the network entities of a core network device (for example, the core network device 130 in FIG. 1A). The source RAN node 110-1 and the target RAN node 110-2 correspond to the access network device 110-1 and 110-2, respectively. The UE AS 121 and the UE APP layer 123 may correspond to network entities of a UE (for example, the terminal device 120 in FIG. 1A).

As shown in FIG. 1B, at 152, the UE joins the network at source RAN node 110-1 for slice 1. At 156, the OAM/CN 133 transmits QoE measurement configuration 154 to the source RAN node 110-1. The QoE measurement configuration 154 contains a network slice scope, e.g., a list of S-NSSAIs {1, 2}.

FIG. 1C illustrates a schematic diagram of a format of a S-NSSAI according to current specifications. As shown in FIG. 1C, the S-NSSAI may include both Slice Service Type (SST) field and Slice Differentiator (SD) field with a total length of 32 bits or include only SST field part in which case the length of S-NSSAI is 8 bits only. The SST field may have standardized and non-standardized values. Values 0 to 127 belong to the standardized SST range. For instance, SST value of 1 may indicate that the slice is suitable for handling of 5G eMBB, SST value of 2 may indicate that the slice is suitable for handling of URLLC, etc. SD is operator-defined only.

Turning back to FIG. 1B, at 160, the source RAN node 110-1 sends the AppLayerConfiguration 158 towards the UE AS 121 including the network slice scope. For Rel-18 UEs, the UE APP layer will be aware of the network slice scope. That is, at 162, the UE AS 121 forwards the AppLayerConfiguration 158 to the UE APP layer 123. At 164, the UE APP layer 123 contains measurements for slice 1. At 168, the UE APP layer 123 reports the measurements to the UE AS 121 via AppLayerMeasurement report 166, indicating slice ID of 1. At 170, the UE AS 121 in turn forwards the AppLayerMeasurement report 166 to the source RAN node 110-1. At 172, the source RAN node 110-1 eventually sends the AppLayerMeasurement report 166 to the MCE/TCE 131 for further analysis.

At 174, the UE handovers to the target RAN node 110-2, where slice 1 is not supported. At 176, the slice 1 is remapped to slice 3 but the UE APP layer 3 is not aware of the slice remapping. At 178, the UE APP layer 123 at current state continues the QoE measurement reporting since it is unaware of the remapped slices and thus it will consider as if the slice remapping never occurred, however the network might not want those QoE reports any longer.

Even if the UE APP layer 123 is aware of the slice remapping, the current QoE reporting poses issues since the UE APP layer 123 will detect that the remapped slice is not part of the network slice scope and as such will stop reporting, yet the network might be still interested in those reports.

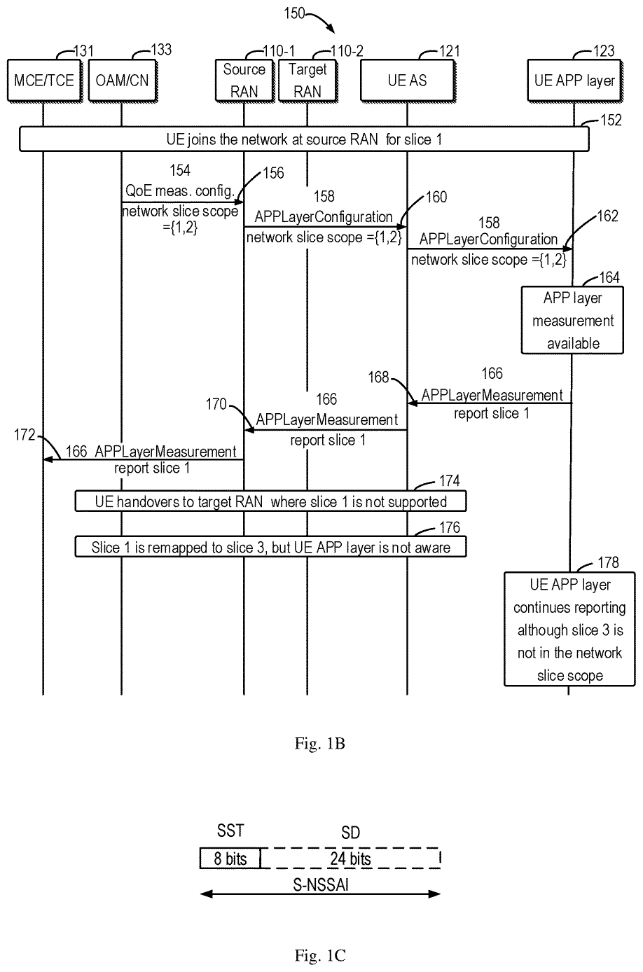

In these cases, current framework of QoE network slice scope is not applicable to the concept of slice-remapping that is to be specified in Rel-18 and brings inconsistencies between UE APP layer and UE AS layer, which may break the principles of QoE reporting of Rel-17. In this disclosure, a solution is provided to overcome these inconsistencies mentioned above and enable the preservation of normal QoE measurement reporting with the introduction of the slice remapping feature. This will be described in connection with FIGS. 2-8.

Reference is now made to FIG. 2, which shows a process 200 for QoE reporting in the event of slice remapping according to an embodiment of the present disclosure. For the purpose of discussion, the process 200 will be described with reference to FIG. 1A. The process 200 may involve the terminal device 120, the network device 110 and the core network device 130 as illustrated in FIG. 1A. The network device 110 may be one of the first access network device 110-1 and the second access network device 110-2 which is in the same radio access network with the terminal device 120. In other words, the network device 110 is connecting and communicating with the terminal device 120. For example, the network device 110 may be the first access network device 110-1 (which may also be referred to as the source access network device 110-1) initially connected to the terminal device 120 without an occurrence of HO procedures. Alternatively, the network device 110 may be the second access network device 110-2 (which may also be referred to as the target access network device 110-2) connected to the terminal device 120 after the HO procedures. It would be appreciated that although the process 200 has been described in the communication system 100 of FIG. 1A, this process may be likewise applied to other communication scenarios.

In the process 200, the core network device 130 transmits (202) to the network device 110, a QoE measurement configuration 204 for the terminal device 120 for continuity of QoE measurement reporting. The QoE measurement configuration 204 is indicative of a first network slice scope and a second network slice scope. The first network slice scope is indicative of one or more first network slices associated with the QoE measurement reporting and the second network slice scope is indicative of one or more second network slices associated with the QoE measurement reporting. At least one of the one or more first network slices is to be remapped to at least one of the one or more second network slices in an event of slice remapping. In some embodiments, the core network device 130 may configure the QoE measurement configuration 204 for a specific terminal device or for a group of terminal device. In some embodiments, the core network device 130 may transmit the QoE measurement configuration 204 to the source access network device 110-1 initially connected to the terminal device 120, or to a group of network devices, e.g., all access network devices in an area.

The network device 110 obtains (206) the QoE measurement configuration 204 from the core network device 130. In addition to obtaining from the core network device 130, the network device 110 may also obtain the QoE measurement configuration 204 in other approaches. For example, the network device 110 may obtain the QoE measurement configuration 204 from an OAM or from a preconfigured configuration. Alternatively, in an event where the network device 110 may be a target network device of a HO procedure e.g., the second access network device 110-2 in FIG. 1A, and the terminal device 120 may be handed over from a source access network device (e.g., the first access network device 110-1 in FIG. 1A) to the target access network device 110-2, the target access network device 110-2 may receive the QoE measurement configuration 204 from the source access network device 110-1.

The terminal device 120 for a radio access network obtains (208) the QoE measurement configuration 204 from the network device 110 for the radio access network. In addition to obtaining from the network device 110 communicating with the terminal device 120, the terminal device 120 may also obtain the QoE measurement configuration 204 in other approaches. For example, in an event where the network device 110 may be a target network device of a HO procedure e.g., the second access network device 110-2 in FIG. 1A, and the terminal device 120 is handed over from a source access network device (e.g., the first access network device 110-1 in FIG. 1A) to the target access network device 110-2, the terminal device 120 may receive the QoE measurement configuration 204 from the source access network device 110-1.

At 210, the event of slice remapping occurs where at least one of the one or more first network slices is remapped to at least one of the one or more second network slices. In response to the occurrence 210 of the event of slice remapping, the terminal device 120 performs (212) the QoE measurement reporting based on the QoE measurement configuration 204. In other words, if the at least one of the one or more first network slices is remapped to at least one of the one or more second network slices in the the QoE measurement configuration 204, the terminal device 120 continues reporting the QoE measurement to the network device 110 communicating with the terminal device 120. In some embodiments, if the at least one of the one or more first network slices is remapped to other network slice(s) than the one or more second network slices in the the QoE measurement configuration 204, the terminal device 120 may stop reporting the QoE measurement to the network device 110 communicating with the terminal device 120. In this way, preservation of normal QoE measurement reporting with the introduction of the slice remapping feature may be enabled.

In some embodiments, the network device 110 may transmit, to the terminal device 120, an indication indicative of an occurrence of the event of the slice remapping. For example, in the occurrence of the event of slice remapping, the network device 110 communicating with the terminal device 120 may transmit, to the terminal device 120, the indication indicative of an occurrence of the event of the slice remapping. The terminal device 120 may receive, from the network device 110, the indication indicative of the occurrence of the event of the slice remapping. In this way, the terminal device may be informed of the event of the slice remapping, and thus determine whether to continue the QoE measurement reporting.

In some embodiments, in order to obtain the QoE measurement configuration, the terminal device 120 may cause an AS of the terminal device 120 to receive the QoE measurement configuration 204 from a network device for the radio access network and cause the AS to send the QoE measurement configuration 204 to an application layer of the terminal device 120. In this way, the application layer of the terminal device may be aware of the second network slice scope for which network slices in the first network slice scope can be remapped to (in the future) and for which QoE measurement reporting can continue even after remapping.

In some embodiments, in order to perform the QoE measurement reporting, the terminal device 120 may cause the AS to inform the application layer of the occurrence of the event of the slice remapping, and cause the application layer to perform the QoE measurement reporting based on the QoE measurement configuration 204. In this way, inconsistencies between APP layer and the AS may be eliminated and preservation of normal QoE measurement reporting with the introduction of the slice remapping feature may be enabled.

In some embodiments, the QoE measurement configuration may be further indicative of priority information associated with the one or more first network slices and/or the one or more second network slices. The network device 110 may determine whether the network device 110 is overloaded. If the network device 110 is overloaded, the network device 110 may transmit an indication to the terminal device 120 based on the priority information. The indication may indicate the terminal device 120 to pause the QoE measurement reporting or release the QoE measurement configuration. The terminal device 120 may receive, from the network device 110 for the radio access network, the indication of pausing the QoE measurement reporting or releasing the QoE measurement configuration. The terminal device 120 may pause the QoE measurement reporting or release the QoE measurement configuration based on the received indication. For example, if the priority of the ongoing network slice either in the one or more first network slices or in the one or more second network slices on which the terminal device is operating is low, the terminal device 120 may pause the QoE measurement reporting or release the QoE measurement configuration when the network device communicating with the terminal device 120 on the ongoing network slice is overloaded. If the priority of the ongoing network slice is high, the terminal device 120 may continue the QoE measurement reporting even when the network device communicating with the terminal device 120 on the ongoing network slice is overloaded. In this way, the QoE report continuity priorities may help the RAN node to choose whether it can continue with the QoE measurement reporting or pause the QoE measurement reporting or release the QoE measurement configuration for a specific remapped slice.

In some embodiments, the network device 110 may transmit the QoE measurement configuration 204 to the terminal device 120. For example, the source access network device 110-1 in FIG. 1A may transmit the QoE measurement configuration 204 to the terminal device 120. In the event that the terminal device 120 is handed over from the first access network device 110-1 to the second access network device 110-2, the first access network device 110-1 may transmit the QoE measurement configuration 204 to the second access network device 110-2 and the second access network device 110-2 may receive the QoE measurement configuration 204 from the first access network device 110-1. In this way, the target access network device may be aware of the second network slice scope and preservation of normal QoE measurement reporting with the introduction of the slice remapping feature may be enabled even with the occurrence of HO procedure.

In some embodiments, in order to obtain the QoE measurement configuration, the network device 110 may receive the QoE measurement configuration 204 from the core network device 130 or an OAM. Alternatively, in order to obtain the QoE measurement configuration, the network device 110 may obtain the QoE measurement configuration 204 from a preconfigured configuration.

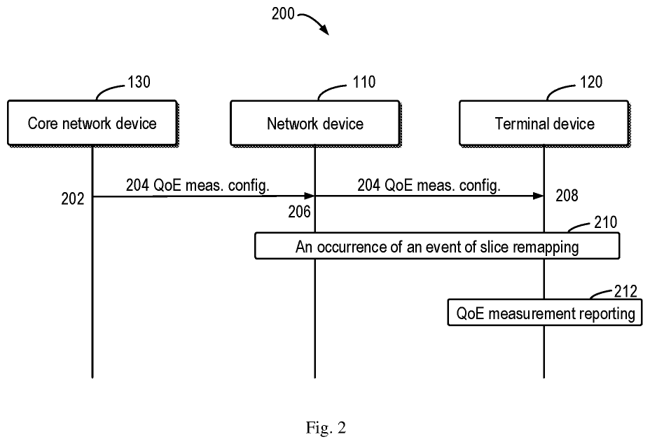

FIGS. 3A and 3B illustrates an example of processes 300A and 300B for QoE reporting in the event of slice remapping in accordance with some example embodiments of the present disclosure. It is noted that the process 300B is a continuation of the process 300A and the processes 300A and 300B can be considered as a more specific example of the process 200 of FIG. 2. The example implementation of FIGS. 3A and 3B is depicted and will be described from perspectives of MCE/TCE 131, OAM/CN 133, source RAN node 110-1, target RAN node 110-2, UE AS 121 and UE APP layer 123. For the purpose of discussion, the processes 300A and 300B will be described with reference to FIG. 1A. The processes 300A and 300B may involve the terminal device 120, the access network devices 110-1, 110-2 and the core network device 130 as illustrated in FIG. 1A. In particular, the MCE/TCE 131 and OAM/CN 133 may correspond to the network entities of a core network device (for example, the core network device 130 in FIG. 1A). The source RAN node 110-1 and the target RAN node 110-2 correspond to the access network device 110-1 and 110-2, respectively. The UE AS 121 and the UE APP layer 123 may correspond to network entities of a UE (for example, the terminal device 120 in FIG. 1A). It is to be understood that processes 300A and 300B may further include additional blocks not shown and/or omit some shown blocks, and the scope of the present disclosure is not limited in this regard.

In the process 300A, at 302, the UE may join the network at source RAN node 110-1 for slice 1. The OAM/CN 133 may configure a QoE measurement configuration 304 for a UE or a group of UEs. The QoE measurement configuration 304 may include a network slice scope and a remapped network slice scope. For example, the network slice scope may refer to the first network slice scope and the remapped network slice scope refer to the second network slice scope. The network slice scope may contain a list of S-NSSAIs, on which the QoE measurement reporting can be performed, e.g., {1, 2} as shown in FIG. 3A. For example, the list of S-NSSAIs may refer to the one or more first network slices. The remapped network slice scope may contain a list of S-NSSAIs that if remapped towards, the QoE measurement reporting can continue, e.g., 131 as shown in FIG. 3A. For example, the list of S-NSSAIs contained in the remapped network slice scope may refer to the one or more second network slices. In some embodiments, for a signaling-based procedure, the OAM/CN 133 may send the QoE measurement configuration 304 to the source RAN node 110-1 at 306. Alternatively, for a management-based procedure, the OAM/CN 133 may send the QoE measurement configuration 304 to multiple RAN nodes including the source RAN node 110-1, for example to all RAN nodes in an area of scope. At 310, the source RAN node 110-1 may send the AppLayerConfiguration 308 towards the UE AS 121. The AppLayerConfiguration 308 may include the network slice scope and remapped network slice scope. At 312, the UE AS 121 may in turn forward the AppLayerConfiguration 308 to the UE APP layer 123.

In other words, the network slice scope sent by the OAM/CN 133 towards the source RAN node 110-1 which is then forwarded towards the UE APP layer 123 through the QoE configuration container may be extended with an additional list of S-NSSAIs which is referred to as the remapped network slice scope. The remapped network slice scope may contain the S-NSSAIs for which network slices in the network slice scope can be remapped to (in the future) and for which QoE measurement reporting can continue even after remapping. For example, the at least one of the one or more first network slices can be remapped to the at least one of the one or more second network slices.

At 314, the QoE measurements for slice 1 may be available. At 318, the UE APP layer 123 may report the QoE measurements to the UE AS 121 via AppLayerMeasurement report 316, indicating slice ID of 1. At 320, the UE AS 121 may in turn forward the AppLayerMeasurement report 316 to the source RAN node 110-1. At 322, the source RAN node 110-1 may eventually send the AppLayerMeasurement report 316 to the MCE/TCE 131 for further analysis.

Reference is now made to FIG. 3B. At 324, the UE may handover to the target RAN node 110-2. In some embodiments, for signaling-based QoE, the remapped network slice scope may also be forwarded from the source RAN node 110-1 towards the target RAN node 110-2 via XnAP/NGAP interface along with the QoE measurement configuration 304 when the UE is handed over from the source RAN node 110-1 to the target RAN node 110-2. Alternatively, for management-based QoE, the target RAN node 110-2 may have received the QoE measurement configuration 304 from the OAM/CN 133. Thus, for management-based QoE, the remapped network slice scope does not need to be forwarded from the source RAN node 110-1 towards the target RAN node 110-2 since the target RAN node 110-2 already contains the QoE measurement configuration 304.

In some embodiments, slice 1 may be not supported by the target RAN node 110-2. At 326, slice 1 may be remapped to slice 3. In some embodiments, the target RAN node 110-2 may transmit an indication indicative of an occurrence of the event of the slice remapping to the UE AS 121. At 328, the UE AS 121 may indicate to the UE APP layer 123 that a slice remapping has occurred and that slice 1 has been remapped to slice 3. Alternatively, the UE APP layer 123 may be informed, via URSP rules as mentioned in TR 23.700-41 V0.3.0 or other means, that a slice remapping has occurred and slice 1 has been remapped to slice 3. As such, the UE APP layer 123 may be aware of the slice remapping.

At 330, the UE may identify that slice 3 is in the remapped network slice scope and thus continue with the QoE measurement reporting. At 332, the UE APP layer 123 may contain the QoE measurements for slice 3. At 334, the UE APP layer 123 may report the QoE measurements to the UE AS 121 via AppLayerMeasurement report 336, indicating slice ID of 3. At 338, the UE AS 121 may in turn forward the AppLayerMeasurement report 336 to the source RAN node 110-1. At 340, the source RAN node 110-1 may eventually send the AppLayerMeasurement report 336 to the MCE/TCE 131 for further analysis.

In order to avoid any unnecessary QoE measurement reports initiated by UE APP layer 123, the remapped network slice scope list may be checked only if a slice remapping occurs. For instance, if the network slice scope contains slice 1 and slice 2, whereas the remapped network slice scope contains slice 3, QoE measurement reports shall be generated by the UE APP layer 123 only when slice 1 or 2 are remapped to slice 3 and not otherwise (i.e., original reports generated directly for slice 3 without remapping). In other words, if the UE is operating on slice 3 without slice remapping occurring, the UE APP layer 123 would not generate QoE measurement reports for slice 3.

In some embodiments, network slice remapping may also occur when the UE communicates with the source RAN node 110-1 without HO procedure. For example, if the ongoing slice 1 is overloaded, slice 1 may be remapped to slice 3. The UE APP layer 123 may be informed that a slice remapping has occurred and slice 1 has been remapped to slice 3. The UE may identify that slice 3 is in the remapped network slice scope and thus continue with the QoE measurement reporting.

In some embodiments, slice 1 may be remapped to another slice different from slices in the network slice scope and the remapped network slice scope. The UE may identify that the remapped slice is not in the remapped network slice scope and thus stop with the QoE measurement reporting. In this way, the continuity of the QoE report may depend on the remapped network slice scope.

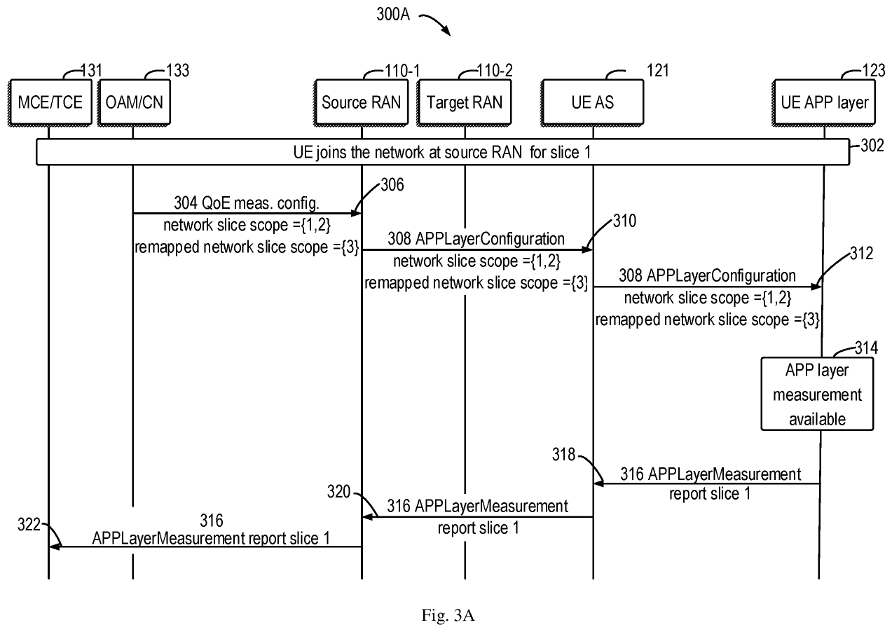

FIG. 4 illustrates another example of a process 400 for QoE reporting in the event of slice remapping in accordance with some example embodiments of the present disclosure. It is noted that the process 400 can be considered as a more specific example of the process 200 of FIG. 2. The example implementation of FIG. 4 is depicted and will be described from perspectives of MCE/TCE 131, OAM/CN 133, source RAN node 110-1, target RAN node 110-2, UE AS 121 and UE APP layer 123. For the purpose of discussion, the process 400 will be described with reference to FIG. 1A. The process 400 may involve the terminal device 120, the access network devices 110-1, 110-2 and the core network device 130 as illustrated in FIG. 1A. In particular, the MCE/TCE 131 and OAM/CN 133 may correspond to the network entities of a core network device (for example, the core network device 130 in FIG. 1A). The source RAN node 110-1 and the target RAN node 110-2 correspond to the access network device 110-1 and 110-2, respectively. The UE AS 121 and the UE APP layer 123 may correspond to network entities of a UE (for example, the terminal device 120 in FIG. 1A). It is to be understood that process 400 may further include additional blocks not shown and/or omit some shown blocks, and the scope of the present disclosure is not limited in this regard.

In the process 400, at 402, the UE may join the network at source RAN node 110-1 for slice 1. The OAM/CN 133 may configure a QoE measurement configuration 404 for a UE or a group of UEs. The QoE measurement configuration 404 may include a network slice scope, a remapped network slice scope and an indication referred to as QoE report continuity priority for each slice in the remapped network slice scope. For example, the network slice scope may refer to the first network slice scope and the remapped network slice scope refer to the second network slice scope. The network slice scope may contain a list of S-NSSAIs, on which the QoE measurement reporting can be performed, e.g., {1, 2} as shown in FIG. 4. For example, the list of S-NSSAIs may refer to the one or more first network slices. The remapped network slice scope may contain a list of S-NSSAIs that if remapped towards, the QoE measurement reporting can continue, e.g., {3, 4} as shown in FIG. 4. For example, the list of S-NSSAIs contained in the remapped network slice scope may refer to the one or more second network slices. The QoE report continuity priority may indicate whether remapping to a particular slice is important or not for OAM/CN and whether QoE measurement reporting shall continue or not accordingly. In the embodiment shown in FIG. 4, the QoE report continuity priority for slice 3 is low, and the QoE report continuity priority for slice 4 is low. At 406, the OAM/CN 133 may send the QoE measurement configuration 404 to the source RAN node 110-1 in a signaling-based procedure. Alternatively, the OAM/CN 133 may send the QoE measurement configuration 404 to all RAN nodes in an area of scope in a management-based procedure. The source RAN node 110-1 may detect that UE meets the criterion that UE operates on slice 1 in the network slice scope, therefore may send the AppLayerConfiguration 408 towards the UE AS 121 at 410. The AppLayerConfiguration 408 may include the network slice scope, remapped network slice scope and the QoE report continuity priority for each slice in the remapped network slice scope. At 412, the UE AS 121 may in turn forward the AppLayerConfiguration 408 to the UE APP layer 123.

In other words, apart from the remapped network slice scope that is sent by the OAM/CN 133 towards the source RAN node 110-1 which is then forwarded towards the UE APP layer 123 through the QoE configuration container, additionally QoE report continuity priorities may also be sent by the OAM/CN 133 towards the source RAN node 110-1. The QoE report continuity priorities may help the RAN node to determine whether it can continue with the QoE measurement reporting or pause the QoE measurement reporting or release the QoE measurement configuration for a specific remapped slice. The proposed QoE report continuity priority may allow differentiation among slices within a QoE configuration container.

At 414, the QoE measurements for slice 1 may be available. At 418, the UE APP layer 123 may report the QoE measurements to the UE AS 121 via AppLayerMeasurement report 416, indicating slice ID of 1. At 420, the UE AS 121 may in turn forward the AppLayerMeasurement report 416 to the source RAN node 110-1. At 422, the source RAN node 110-1 may eventually send the AppLayerMeasurement report 416 to the MCE/TCE 131 for further analysis.

At 424, the UE may handover to the target RAN node 110-2. In some embodiments, for signaling-based QoE, the remapped network slice scope and the QoE report continuity priorities may also be forwarded from the source RAN node 110-1 towards the target RAN node 110-2 via XnAP/NGAP interface along with the QoE measurement configuration 404 when the UE is handed over from the source RAN node 110-1 to the target RAN node 110-2. Alternatively, for management-based QoE, the target RAN node 110-2 may have received the QoE measurement configuration 404 from the OAM/CN 133. Thus, for management-based QoE, the remapped network slice scope and QoE report continuity priorities do not need to be forwarded from the source RAN node 110-1 towards the target RAN node 110-2 since the target RAN node 110-2 already contains the QoE measurement configuration 404.

In some embodiments, slice 1 may be not supported by the target RAN node 110-2. At 426, slice 1 may be remapped to slice 3 and the UE APP layer 123 may be aware of the slice remapping. Since slice 3 is in the remapped network slice scope, the QoE measurement reporting may be continued.

At 428, the target RAN node 110-2 may be overloaded. Since the target RAN node 110-2 has received the remapped network slice scope and the QoE report continuity priority information from the source RAN node in signaling-based QoE or contains it in case of management-based QoE, given the fact that priority for slice 3 is low, the target RAN node 110-2 may determine to pause the QoE measurement reporting or release the QoE measurement configuration at 430. At 434, the target RAN node 110-2 may transmit, to the UE, AppLayerConfiguration 432 to pause the QoE measurement reporting or release the QoE measurement configuration. In other words, based on the QoE report continuity priority information received from the OAM/CN, if the priority is low for a remapped slice, the QoE measurement configuration may be released by the RAN node or the QoE measurement reporting may be paused when the RAN node is overloaded and the UE may be notified accordingly.

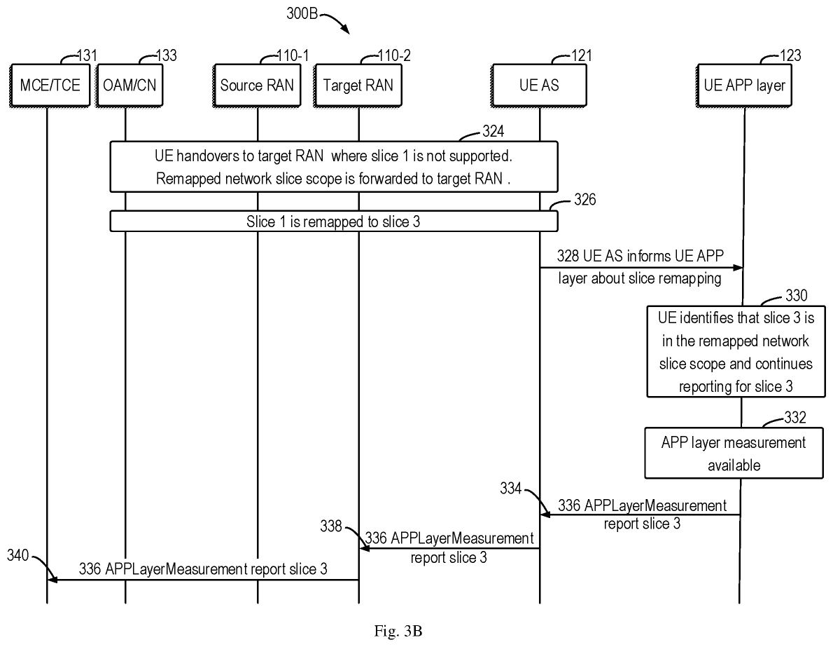

FIG. 5 illustrates a further example of a process 500 for QoE reporting in the event of slice remapping in accordance with some example embodiments of the present disclosure. It is noted that the process 500 can be considered as a more specific example of the process 200 of FIG. 2. The example implementation of FIG. 5 is depicted and will be described from perspectives of MCE/TCE 131, OAM/CN 133, source RAN node 110-1, target RAN node 110-2, UE AS 121 and UE APP layer 123. For the purpose of discussion, the process 500 will be described with reference to FIG. 1A. The process 500 may involve the terminal device 120, the access network devices 110-1, 110-2 and the core network device 130 as illustrated in FIG. 1A. Similar reference numerals are used to denote the steps or components described in FIG. 5 having the same operations as the steps or components described in FIG. 4, and detailed description thereof will be omitted. It is to be understood that process 500 may further include additional blocks not shown and/or omit some shown blocks, and the scope of the present disclosure is not limited in this regard.

In the process 500, at 502, the UE may join the network at source RAN node 110-1 for slice 1. The OAM/CN 133 may configure a QoE measurement configuration 504 for a UE or a group of UEs. The QoE measurement configuration 504 may include a network slice scope, a remapped network slice scope and an indication referred to as QoE report continuity priority for each slice in the remapped network slice scope. For example, the network slice scope may refer to the first network slice scope and the remapped network slice scope refer to the second network slice scope. In the embodiment shown in FIG. 5, the network slice scope is {1, 2}, the remapped network slice scope is {3, 4}, the QoE report continuity priority for slice 3 is high and the QoE report continuity priority for slice 4 is low, respectively. For example, the network slice scope {1, 2} contained in the network slice scope may refer to the one or more first network slices, and the remapped network slice scope is {3, 4} contained in the remapped network slice scope may refer to the one or more second network slices. For example, the QoE measurement configuration may include the priority associated with the one or more second network slices. The OAM/CN 133 may send the QoE measurement configuration 504 to the source RAN node 110-1. The source RAN node 110-1 may detect that UE meets the criterion that UE operates on slice 1 in the network slice scope, therefore may send the AppLayerConfiguration 508 towards the UE AS 121 at 510. At 512, the UE AS 121 may in turn forward the AppLayerConfiguration 508 to the UE APP layer 123.

At 514, the QoE measurements for slice 1 may be available. At 518, the UE APP layer 123 may report the QoE measurements to the UE AS 121 via AppLayerMeasurement report 516, indicating slice ID of 1. At 520, the UE AS 121 may in turn forward the AppLayerMeasurement report 516 to the source RAN node 110-1. At 522, the source RAN node 110-1 may eventually send the AppLayerMeasurement report 516 to the MCE/TCE 131 for further analysis.

At 524, the UE may handover to the target RAN node 110-2. In some embodiments, for signaling-based QoE, the remapped network slice scope and the QoE report continuity priorities may also be forwarded from the source RAN node 110-1 towards the target RAN node 110-2 via XnAP/NGAP interface along with the QoE measurement configuration 504 when the UE is handed over from the source RAN node 110-1 to the target RAN node 110-2. Alternatively, for management-based QoE, the target RAN node 110-2 may have received the QoE measurement configuration 504 from the OAM/CN 133. Thus, for management-based QoE, the remapped network slice scope and QoE report continuity priorities do not need to be forwarded from the source RAN node 110-1 towards the target RAN node 110-2 since the target RAN node 110-2 already contains the QoE measurement configuration 504.

In some embodiments, slice 1 may be not supported by the target RAN node 110-2. At 526, slice 1 may be remapped to slice 3 and the UE APP layer 123 may be aware of the slice remapping. Since slice 3 is in the remapped network slice scope, the QoE measurement reporting may be continued.

At 528, the target RAN node 110-2 may be overloaded. Given the fact that priority for slice 3 is high, the target RAN node 110-2 may determine that the QoE measurement reporting may be continued at 530. As shown in FIG. 5, even though the target RAN node 110-2 is overloaded, the QoE job remains. At 532, the QoE measurements for slice 3 may be available. At 536, the UE APP layer 123 may report the QoE measurements to the UE AS 121 via AppLayerMeasurement report 534, indicating slice ID of 3. At 538, the UE AS 121 may in turn forward the AppLayerMeasurement report 534 to the source RAN node 110-1. At 540, the source RAN node 110-1 may eventually send the AppLayerMeasurement report 534 to the MCE/TCE 131 for further analysis. In other words, based on the QoE report continuity priority information received from the OAM/CN, if the priority is high for a remapped slice, the QoE measurement reporting may continue even when the RAN node is overloaded since the UE APP layer is aware both of the extended network slice scope and slice remapping information.

In this way, the continuity of the QoE report may depend on the remapped network slice scope and the corresponding QoE report continuity priority of the remapped slice when RAN node is overloaded.

Although the QoE report continuity priority is associated with slices in the remapped network slice scope and is used in case of slice remapping, a similar approach may be used to differentiate priority of slices within a QoE measurement configuration for the network slice scope. For example, in the embodiment of FIG. 5, the QoE measurement configuration 504 may further include QoE report continuity priority for each slice in the network slice scope {1, 2}, i.e. the QoE measurement configuration 504 may further include QoE report continuity priority for the one or more first network slices For example, the QoE report continuity priorities for the ongoing slice 1 may be high. In such situation, when no slice remapping occurs and the UE is communicating with the source RAN node 110-1 on slice 1, the QoE measurement reporting may be continued even if the source RAN node 110-1 is overloaded. If the QoE report continuity priority for the ongoing slice 1 is low, the source RAN node 110-1 may determine to pause the QoE measurement reporting or release the QoE measurement configuration when the source RAN node 110-1 is overloaded.

The rationale why the OAM/CN would be interested to differentiate slice remapping by introducing priorities could be twofold. First, due to the nature of slice remapping, which is in general introduced to provide PDU session continuity, especially if the previous slice is remapped to a default and basic slice that only provides best effort quality, then OAM/CN might not be interested in the QoE reports. On the other hand, the OAM/CN might be particularly interested in reports during slice remapping in order to identify which of the remapped slices achieve the best performance and in that case may use this information to construct the list of remapping slice opportunities that are sent to the RAN node for selection.

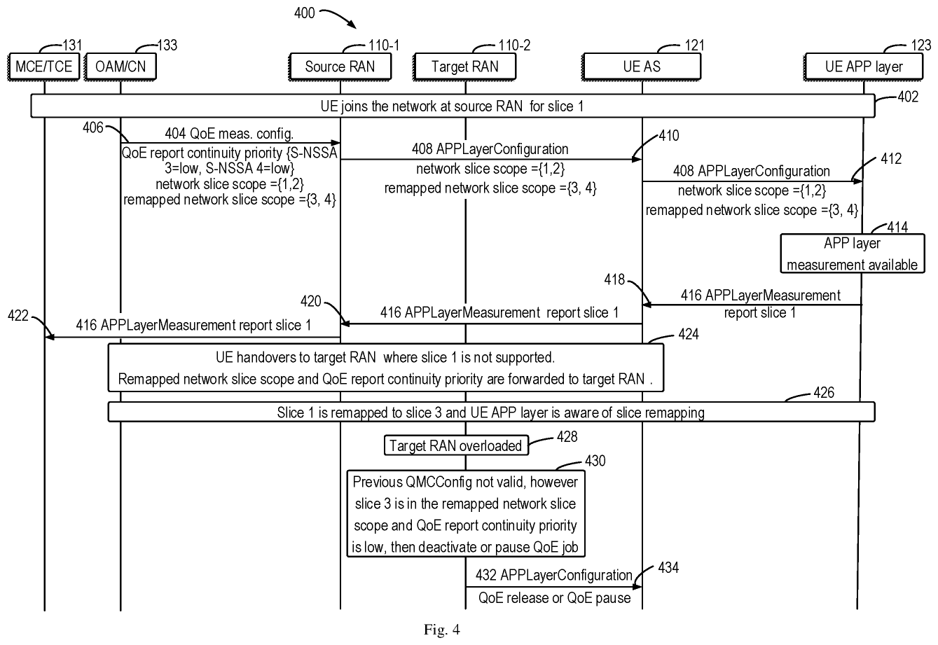

FIG. 6 shows a flowchart of an example method 600 implemented at a terminal device in accordance with some embodiments of the present disclosure. For the purpose of discussion, the method 600 will be described from the perspective of the terminal device 120 with reference to FIG. 1A.

At block 610, the terminal device 120 for a radio access network obtains a QoE measurement configuration for continuity of QoE measurement reporting. The QoE measurement configuration is indicative of a first network slice scope and a second network slice scope. The first network slice scope is indicative of one or more first network slices associated with the QoE measurement reporting and the second network slice scope is indicative of one or more second network slices associated with the QoE measurement reporting. At least one of the one or more first network slices is to be remapped to at least one of the one or more second network slices in an event of slice remapping. At block 620, the terminal device 120 determines whether the event of slice remapping occurs. In response to an occurrence of the event of slice remapping, at block 630, the terminal device 120 performs the QoE measurement reporting based on the QoE measurement configuration.

In some embodiments, the terminal device 120 may receive, from a network device for the radio access network, an indication indicative of the occurrence of the event of the slice remapping. In some embodiments, in order to obtain the QoE measurement configuration, the terminal device 120 may cause an AS of the terminal device 120 to receive the QoE measurement configuration from a network device for the radio access network and cause the AS to send the QoE measurement configuration to an application layer of the terminal device 120. In some embodiments, in order to perform the QoE measurement reporting, the terminal device 120 may cause the AS to inform the application layer of the occurrence of the event of the slice remapping, and cause the application layer to perform the QoE measurement reporting based on the QoE measurement configuration.

In some embodiments, the terminal device 120 may receive, from a network device for the radio access network, an indication of pausing the QoE measurement reporting or releasing the QoE measurement configuration. The terminal device 120 may pause the QoE measurement reporting or release the QoE measurement configuration based on the received indication.

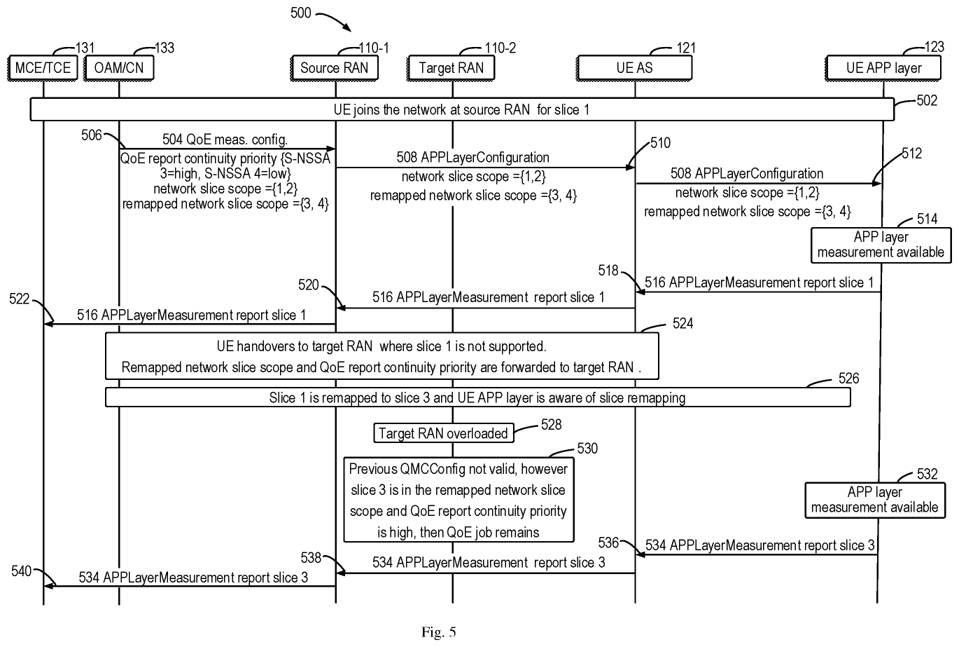

FIG. 7 shows a flowchart of an example method 700 implemented at a network device in accordance with some embodiments of the present disclosure. For the purpose of discussion, the method 700 will be described from the perspective of the network device 110 with reference to FIG. 1A.

At block 710, the network device 110 obtains a QoE measurement configuration for continuity of QoE measurement reporting. The QoE measurement configuration is indicative of a first network slice scope and a second network slice scope. The first network slice scope is indicative of one or more first network slices associated with the QoE measurement reporting and the second network slice scope is indicative of one or more second network slices associated with the QoE measurement reporting. At least one of the one or more first network slices is to be remapped to at least one of the one or more second network slices in an event of slice remapping.

In some embodiments, the QoE measurement configuration may be further indicative of priority information associated with the one or more first network slices and/or the one or more second network slices. In some embodiments, the network device 110 may determine whether the network device 110 is overloaded. Based on determining that the network device 110 is overloaded, the network device 110 may transmit an indication to the terminal device 120 based on the priority information. The indication may indicate the terminal device 120 to pause the QoE measurement reporting or release the QoE measurement configuration.

In some embodiments, the network device 110 may transmit the QoE measurement configuration to the terminal device 120. In some embodiments, the network device 110 may be a first network device 110-1. In an event that the terminal device 120 is handed over from the first network device 110-1 to a second network device 110-2 for the radio access network, the network device 110-1 may transmit the QoE measurement configuration to the second network device 110-2.

In some embodiments, in order to obtain the QoE measurement configuration, the network device 110 may receive the QoE measurement configuration from the core network device 130 or an OAM. Alternatively, in order to obtain the QoE measurement configuration, the network device 110 may obtain the QoE measurement configuration from a preconfigured configuration.

In some embodiments, the network device 110 may be a second network device 110-2. In order to obtain the QoE measurement configuration, the second network device 110-2 may receive the QoE measurement configuration from a first network device 110-1, in the event that the terminal device 120 is handed over from the first network device 110-1 for the radio access network to the second network device 110-2. In some embodiments, the network device 110 may transmit, to the terminal device 120, an indication indicative of an occurrence of the event of the slice remapping.

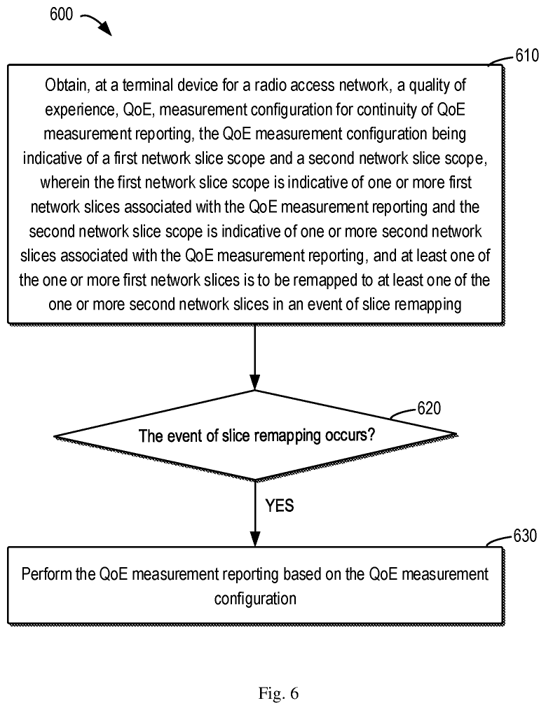

FIG. 8 shows a flowchart of an example method 800 implemented at a core network device in accordance with some embodiments of the present disclosure. For the purpose of discussion, the method 800 will be described from the perspective of the core network device 130 with reference to FIG. 1A.

At block 810, the core network device 130 transmits, to a network device 110 for a radio access network, a QoE measurement configuration for continuity of QoE measurement reporting. The QoE measurement configuration is indicative of a first network slice scope and a second network slice scope. The first network slice scope is indicative of one or more first network slices associated with the QoE measurement reporting and the second network slice scope is indicative of one or more second network slices associated with the QoE measurement reporting. At least one of the one or more first network slices is to be remapped to at least one of the one or more second network slices in an event of slice remapping.

In some embodiments, the QoE measurement configuration may be further indicative of priority information associated with the one or more first network slices and/or the one or more second network slices.

In some embodiments, an apparatus capable of performing any of the method 600 (for example, the terminal device 120) may comprise means for performing the respective steps of the method 600. The means may be implemented in any suitable form. For example, the means may be implemented in a circuitry or software module.

In some embodiments, the apparatus comprises means for obtaining, at a terminal device for a radio access network, a quality of experience, QoE, measurement configuration for continuity of QoE measurement reporting, the QoE measurement configuration being indicative of a first network slice scope and a second network slice scope, wherein the first network slice scope is indicative of one or more first network slices associated with the QoE measurement reporting and the second network slice scope is indicative of one or more second network slices associated with the QoE measurement reporting, and at least one of the one or more first network slices is to be remapped to at least one of the one or more second network slices in an event of slice remapping; and means for performing the QoE measurement reporting based on the QoE measurement configuration in response to an occurrence of the event of slice remapping.

In some embodiments, the apparatus may further comprise means for receiving, from a network device for the radio access network, an indication indicative of the occurrence of the event of the slice remapping. In some embodiments, the means for obtaining the QoE measurement configuration may comprise means for causing an AS of the apparatus to receive the QoE measurement configuration from a network device for the radio access network and means for causing the AS to send the QoE measurement configuration to an application layer of the apparatus. In some embodiments, the means for performing the QoE measurement reporting may comprise means for causing the AS to inform the application layer of the occurrence of the event of the slice remapping, and means for causing the application layer to perform the QoE measurement reporting based on the QoE measurement configuration.

In some embodiments, the apparatus may further comprise means for receiving, from a network device for the radio access network, an indication of pausing the QoE measurement reporting or releasing the QoE measurement configuration, and means for pausing the QoE measurement reporting or releasing the QoE measurement configuration based on the received indication.

In some embodiments, the apparatus further comprises means for performing other steps in some embodiments of the method 600. In some embodiments, the means comprises at least one processor and at least one memory including computer program code, the at least one memory and computer program code configured to, with the at least one processor, cause the performance of the apparatus.

In some embodiments, an apparatus capable of performing any of the method 700 (for example, the network device 110) may comprise means for performing the respective steps of the method 700. The means may be implemented in any suitable form. For example, the means may be implemented in a circuitry or software module.

In some embodiments, the apparatus comprises: means for obtaining, at a network device for a radio access network, a QoE measurement configuration for a terminal device for the radio access network for continuity of QoE measurement reporting, the QoE measurement configuration being indicative of a first network slice scope and a second network slice scope, wherein the first network slice scope is indicative of one or more first network slices associated with the QoE measurement reporting and the second network slice scope is indicative of one or more second network slices associated with the QoE measurement reporting, and at least one of the one or more first network slices is to be remapped to at least one of the one or more second network slices in an event of slice remapping.

In some embodiments, the QoE measurement configuration may be further indicative of priority information associated with the one or more first network slices and/or the one or more second network slices. In some embodiments, the apparatus may further comprise means for determining whether the apparatus is overloaded and means for transmitting an indication to the terminal device based on the priority information based on determining that the apparatus is overloaded, wherein the indication may indicate the terminal device to pause the QoE measurement reporting or release the QoE measurement configuration.

In some embodiments, the apparatus may further comprise means for transmitting the QoE measurement configuration to the terminal device. In some embodiments, the apparatus may be a first network device. The apparatus may further comprise means for transmitting the QoE measurement configuration to a second network device in an event that the terminal device is handed over from the first network device to the second network device for the radio access network.

In some embodiments, the means for obtaining the QoE measurement configuration may comprise means for receiving the QoE measurement configuration from the core network device or an OAM. Alternatively, the means for obtaining the QoE measurement configuration may comprise means for obtaining the QoE measurement configuration from a preconfigured configuration.

In some embodiments, the apparatus may be a second network device. The means for obtaining the QoE measurement configuration may comprise means for receiving the QoE measurement configuration from a first network device, in the event that the terminal device is handed over from the first network device for the radio access network to the second network device. In some embodiments, the apparatus may further comprise means for transmitting, to the terminal device, an indication indicative of an occurrence of the event of the slice remapping.

In some embodiments, the apparatus further comprises means for performing other steps in some embodiments of the method 700. In some embodiments, the means comprises at least one processor and at least one memory including computer program code, the at least one memory and computer program code configured to, with the at least one processor, cause the performance of the apparatus.

In some embodiments, an apparatus capable of performing any of the method 800 (for example, the core network device 130) may comprise means for performing the respective steps of the method 800. The means may be implemented in any suitable form. For example, the means may be implemented in a circuitry or software module.

In some embodiments, the apparatus comprises means for transmitting, at a core network device and to a network device for a radio access network, a quality of experience, QoE, measurement configuration for a terminal device for the radio access network for continuity of QoE measurement reporting, the QoE measurement configuration being indicative of a first network slice scope and a second network slice scope, wherein the first network slice scope is indicative of one or more first network slices associated with the QoE measurement reporting and the second network slice scope is indicative of one or more second network slices associated with the QoE measurement reporting, and at least one of the one or more first network slices is to be remapped to at least one of the one or more second network slices in an event of slice remapping.

In some embodiments, the QoE measurement configuration may be further indicative of priority information associated with the one or more first network slices and/or the one or more second network slices.

In some embodiments, the apparatus further comprises means for performing other steps in some embodiments of the method 800. In some embodiments, the means comprises at least one processor and at least one memory including computer program code, the at least one memory and computer program code configured to, with the at least one processor, cause the performance of the apparatus.

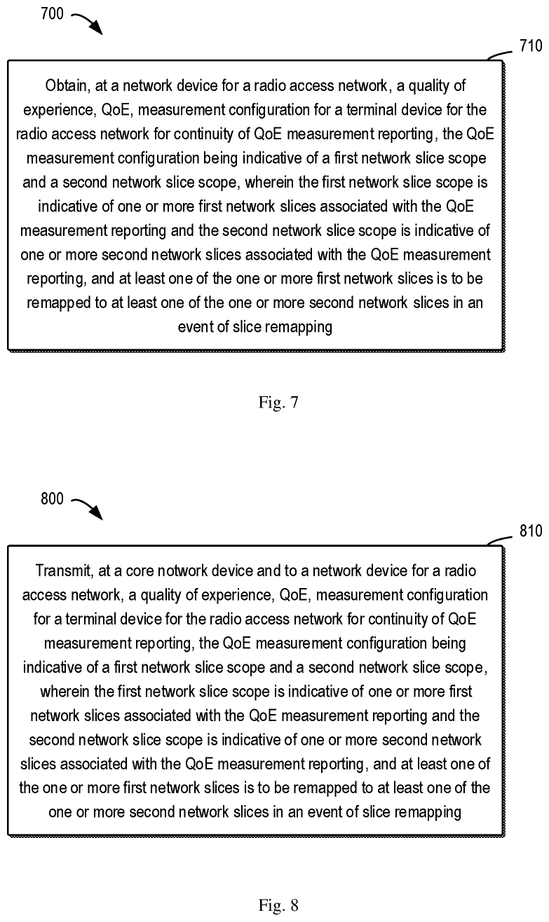

FIG. 9 is a simplified block diagram of a device 900 that is suitable for implementing embodiments of the present disclosure. The device 900 may be provided to implement the communication device, for example the terminal device 120, the network device 110 or the core network device 130 as shown in FIG. 1A. As shown, the device 900 includes one or more processors 910, one or more memories 920 coupled to the processor 910, and one or more communication modules 940 coupled to the processor 910.

The communication module 940 is for bidirectional communications. The communication module 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 920. The processor 910 may perform any suitable actions and processing by loading the program 930 into the RAM 920.

The embodiments of the present disclosure may be implemented by means of the program 930 so that the device 900 may perform any process of the disclosure as discussed with reference to FIGS. 2-8. The embodiments of the present disclosure may also be implemented by hardware or by a combination of software and hardware.

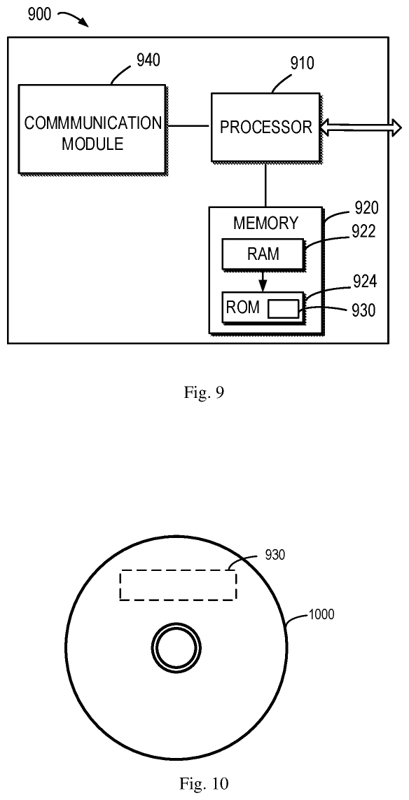

In some embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like. FIG. 10 shows an example of the computer readable medium 1000 in form of CD or DVD. The computer readable medium has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods as described above with reference to FIGS. 2-8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-22. (canceled)

23. A terminal device for a radio access network, the terminal device comprising:
a processor; and
a memory storing computer-executable instructions that, when executed by the processor, cause the terminal device to perform the following operations:
receiving, from a radio access network node in an RRCReconfiguration message that includes an application-layer configuration container, a Quality of Experience (QoE) measurement configuration that includes: (i) a first network slice scope comprising a first list of Single-Network Slice Selection Assistance Information (S-NSSAI), and (ii) a remapped network slice scope comprising a second list of S-NSSAI different from the first list, wherein the remapped network slice scope identifies only remapped to S-NSSAIs for which QoE reporting is permitted after slice remapping;
causing an access stratum (AS) layer of the terminal device to forward the QoE measurement configuration from the AS layer to an application (APP) layer of the terminal device;
while operating on an S-NSSAI contained in the first network slice scope, receiving from the radio access network node an indication that a slice remapping event has occurred, the indication identifying (a) an original S-NSSAI from the first network slice scope and (b) a remapped-to S-NSSAI;
in response to receiving the indication, determining whether the remapped to S-NSSAI identified by the indication is included in the remapped network slice scope; and
based on the remapped to S-NSSAI identified by the indication is included in the remapped network slice scope, generating, at the APP layer, a QoE measurement report that includes the remapped-to S-NSSAI, and transmit the QoE measurement report to the radio access network node, wherein the instructions further cause the terminal device to refrain from generating the QoE measurement report for an S-NSSAI that is included in the remapped network slice scope unless the slice remapping event is indicated as having occurred, wherein the QoE measurement report is only generated when the remapped to S-NSSAI identified by the indication is included in the remapped network slice scope.

24. The terminal device of claim 23, wherein the QoE measurement configuration further includes priority information associated with at least one S-NSSAI in the remapped network slice scope, the priority information indicating whether QoE reporting is to be maintained when a radio access network node is overloaded.

25. The terminal device of claim 24, wherein the oper further comprise:
receiving, from the radio access network node, an indication to pause QoE measurement reporting based on the priority information; and
pausing generation of the QoE measurement report in response to the indication.

26. The terminal device of claim 24, wherein when the priority information associated with the remapped-to S-NSSAI indicates a high priority, the terminal device continues generating and transmitting the QoE measurement report even when the radio access network node is overloaded.

27. The terminal device of claim 26, wherein the indication that the slice remapping event has occurred is received via the access stratum layer, and the operations further comprise causing the access stratum layer to explicitly notify the application layer that the original S-NSSAI has been remapped to the remapped-to S-NSSAI.

28. The terminal device of claim 27, wherein the operations further comprise: encapsulating the QoE measurement report in an application-layer measurement container and transmitting the encapsulated QoE measurement report to the radio access network node via the access stratum layer.

29. The terminal device of claim 28, wherein the remapped network slice scope comprises a predefined list of S-NSSAIs for which QoE reporting continuity is permitted only after a slice remapping event from an S-NSSAI included in the first network slice scope.

30. The terminal device of claim 29, wherein the QoE measurement configuration is maintained at the terminal device during a handover from a source radio access network node to a target radio access network node.

31. The terminal device of claim 30, wherein the indication that the slice remapping event has occurred is received from the target radio access network node after completion of the handover.

32. The terminal device of claim 31, wherein when the remapped-to S-NSSAI identified by the indication is not included in the remapped network slice scope, the terminal device terminates the QoE measurement reporting associated with the original S-NSSAI.

33. A method performed by a terminal device, the method comprising:
receiving, from a radio access network node in an RRCReconfiguration message that includes an application-layer configuration container, a Quality of Experience (QoE) measurement configuration that includes: (i) a first network slice scope comprising a first list of Single-Network Slice Selection Assistance Information (S-NSSAI), and (ii) a remapped network slice scope comprising a second list of S-NSSAI different from the first list, wherein the remapped network slice scope identifies only remapped to S-NSSAIs for which QoE reporting is permitted after slice remapping;
causing an access stratum (AS) layer of the terminal device to forward the QoE measurement configuration from the AS layer to an application (APP) layer of the terminal device;
while operating on an S-NSSAI contained in the first network slice scope, receiving from the radio access network node an indication that a slice remapping event has occurred, the indication identifying (a) an original S-NSSAI from the first network slice scope and (b) a remapped-to S-NSSAI;
in response to receiving the indication, determining whether the remapped to S-NSSAI identified by the indication is included in the remapped network slice scope; and
based on the remapped to S-NSSAI identified by the indication is included in the remapped network slice scope, generating, at the APP layer, a QoE measurement report that includes the remapped-to S-NSSAI, and transmit the QoE measurement report to the radio access network node, wherein the instructions further cause the terminal device to refrain from generating the QoE measurement report for an S-NSSAI that is included in the remapped network slice scope unless the slice remapping event is indicated as having occurred, wherein the QoE measurement report is only generated when the remapped to S-NSSAI identified by the indication is included in the remapped network slice scope.

34. The method of claim 33, wherein the QoE measurement configuration further includes priority information associated with at least one S-NSSAI in the remapped network slice scope, the priority information indicating whether QoE reporting is to be maintained when a radio access network node is overloaded.

35. The method of claim 34, further comprising:
receiving, from the radio access network node, an indication to pause QoE measurement reporting based on the priority information; and
pausing generation of the QoE measurement report in response to the indication.

36. The method of claim 34, wherein when the priority information associated with the remapped-to S-NSSAI indicates a high priority, the terminal device continues generating and transmitting the QoE measurement report even when the radio access network node is overloaded.

37. The method of claim 36, wherein the indication that the slice remapping event has occurred is received via the access stratum layer, and the operations further comprise causing the access stratum layer to explicitly notify the application layer that the original S-NSSAI has been remapped to the remapped-to S-NSSAI.

38. The method of claim 37, further comprising: encapsulating the QoE measurement report in an application-layer measurement container and transmitting the encapsulated QoE measurement report to the radio access network node via the access stratum layer.

39. The method of claim 38, wherein the remapped network slice scope comprises a predefined list of S-NSSAIs for which QoE reporting continuity is permitted only after a slice remapping event from an S-NSSAI included in the first network slice scope.

40. The terminal device of claim 39, wherein the QoE measurement configuration is maintained at the terminal device during a handover from a source radio access network node to a target radio access network node.

41. The terminal device of claim 40, wherein the indication that the slice remapping event has occurred is received from the target radio access network node after completion of the handover.

42. The terminal device of claim 41, wherein when the remapped-to S-NSSAI identified by the indication is not included in the remapped network slice scope, the terminal device terminates the QoE measurement reporting associated with the original S-NSSAI.
